(19) United States
(12) Patent Application Publication
(10) Pub. No.: US 2024/0416633 A1
(43) Pub. Date: Dec. 19, 2024

(54) COMPOSITE FILM FOR THE CONSTRUCTION SECTOR

(71) Applicant: Ewald Dörken AG, Herdecke (DE)

(72) Inventors: Ronald Flaig, Leverkusen (DE); Thomas Bachon, Düsseldorf (DE); Norbert Klingelhage, Wetter (DE); Massimo Concas, Wetter (DE)

(73) Assignee: Ewald Dörken AG, Herdecke (DE)

(21) Appl. No.: 18/712,585

(22) PCT Filed: Aug. 18, 2022
(86) PCT No.: PCT/EP2022/073031

§ 371 Date: May 22, 2024

(30) Foreign Application Priority Data
Nov. 25, 2021 (DE) 10 2021 130 932.8

(51) Int. Cl. B32B 27/40; B32B 5/02; B32B 5/18; B32B 27/06; B32B 27/30; B32B 27/32; B32B 27/36

(52) U.S. Cl. CPC B32B 27/40; B32B 5/022; B32B 5/18; B32B 27/065; B32B 27/308; B32B 27/32; B32B 27/36; B32B 2262/0276; B32B 2262/0292; B32B 2266/0242; B32B 2266/0278; B32B 2307/54; B32B 2307/726; B32B 2419/06

(57) ABSTRACT

The invention relates to the technical field of construction, in particular the building or the construction of roofs and/or facades. In particular, the present invention relates to a composite film for the building sector and to the use thereof inter alia as a roof web and/or facade web.

### CROSS-REFERENCE TO RELATED APPLICATION

The present application is the U.S. national stage application of international application PCT/EP2022/073031 filed Aug. 18, 2022, which international application was published on Jun. 1, 2023, as International Publication WO 2023/094040. The international application claims priority to German Patent Application No. 102021130932.8 filed Nov. 25, 2021. The international application and the German application are hereby incorporated herein by reference in their entireties.

### FIELD

The present invention relates to the technical field of the construction sector, in particular to the construction and/or design of roofs and/or facades.

### SUMMARY

In particular, the present invention relates to a composite film for the building sector and its use, inter alia, as a roof and/or facade membrane.

Composite films used in the construction sector serve to protect and maintain the value of buildings, building materials and/or for covering, in particular, buildings. In particular, composite films can be used as facade membranes, construction films and/or roofing membranes. For example, composite films are intended to protect buildings or the like from the weather, in particular from rain, snow, moisture, cold, heat and/or wind.

In order to be able to guarantee these functions, composite films must be waterproof on the one hand, but also permeable to water vapor on the other, in order to ensure a diffusion-open, or at least diffusion-blocking, and yet waterproof configuration of the building or roof, in particular the sub-roof. Protection against moisture (e.g. from condensation underneath the roof covering), drifting snow and dirt is particularly important for the roof structure.

Various composite films are known in practice, which in particular comprise a multi-layer structure or a structure consisting of several layers. Typically, such a multi-layer structure comprises a carrier layer and a functional layer.

For example, film structures are known that consist of a non-woven layer as a carrier material and a microporous or monolithic membrane applied to it. These films generally have a very high water tightness with good water vapor permeability, but in particular when using polyolefin membranes, the aging resistance is usually not given to the desired extent. To make matters worse, the functional layer, i.e. the membrane, is exposed to the weather and in particular to incident UV radiation, which can lead to premature ageing and a premature deterioration in the barrier properties of the film.

In addition, other film structures are known in which a carrier material, in particular in the form of a polyester nonwoven, is coated with an acrylate layer as a functional layer. The advantage of acrylates is that they are not or only very slowly attacked by UV radiation, in particular with the additional use of UV stabilizers and UV absorbers, and also comprise a high water vapor permeability. However, the disadvantage of this system is that the water tightness without hydrophobing is also inadequate and air tightness is often not achieved to the desired extent. In particular, the high water permeability of non-hydrophobic acrylate coatings is problematic, as hydrophobing agents are often configured on the basis of perfluorinated or partially fluorinated organic compounds, which should no longer be used if possible for reasons of environmental and health protection or whose use is prohibited by regulatory measures in the future.

Furthermore, systems are also known which comprise a carrier layer, a functional layer in the form of a membrane and a further protective layer. The functional layer of the composite film ensures the waterproofness, water vapor permeability and/or windproofness of the composite film. Protective layers or carrier layers arranged around the functional layer serve to protect the functional layer, in particular against mechanical stress or UV radiation.

Such systems with at least three different layers can theoretically compensate for the disadvantages of two-layer structures described above, but the grammage and the amount of material used are always increased, which leads to significantly higher production costs. In addition, producing the film becomes more complicated the more layers it comprises, as the compatibility of the individual materials must also be taken into account to prevent unintentional delamination during use.

In practice, therefore, systems are generally used that comprise one or more microporous or monolithic membranes or acrylate coatings in addition to the carrier layer.

Central aspects in the development and further development of composite films for the construction sector, in particular facade and roofing membranes, are the continuous improvement of the mechanical and physical properties of the composite film and, on the other hand, the optimization of the use of resources and materials. As a rule, however, it can be observed that an increase in the strength values of the composite film, for example, is accompanied by an increase in the material required for the carrier or protective layer. At the same time, the saving of film material often results in a decrease in relevant property parameters of a composite film according to. According to this, the optimization of mechanical and physical properties as well as the use of materials regularly represents a special challenge in the development of composite films.

In the state of the art, there is still a lack of composite films comprising an optimized ratio of mechanical and physical properties as well as material use and combination.

The object of the present invention is therefore to eliminate the aforementioned disadvantages associated with the prior art, or at least to mitigate them.

In particular, one object of the present invention is to provide a composite film which is characterized by improved and reproducible product properties with a simultaneously material- and resource-optimized configuration.

The subject-matter of the present invention according to a first aspect of the present invention is thus a composite film according to claim 1; further advantageous configurations of this aspect of the invention are the subject-matter of the dependent claims relating thereto.

A further subject-matter of the present invention according to a second aspect of the present invention is the use of a composite film according to the invention in the construction sector, in particular as a roofing and/or facade membrane, according to claim 20.

A further subject-matter of the present invention according to a third aspect of the present invention is a method for producing a composite film according to claim 21.

It goes without saying that special features, characteristics, embodiments and embodiments as well as advantages or the like which are explained below—for the purpose of avoiding unnecessary repetition—only in relation to one aspect of the invention, naturally apply according to the other aspects of the invention, without the need for express mention.

In addition, it should be noted that in the case of all the relative or percentage, in particular weight-related, quantities mentioned below, these are to be selected by the skilled person in the context of the present invention in such a way that the sum of the ingredients, additives or auxiliary substances or the like always results in 100 percent or 100 wt. %. However, this is self-evident to the person skilled in the art.

In addition, it is also the case that all the parameter details or the like mentioned below can in principle be determined or ascertained using standardized or explicitly stated determination methods or using determination methods that are familiar to the skilled person.

With this in mind, the subject-matter of the present invention is explained in more detail below.

### BRIEF DESCRIPTION OF THE DRAWINGS

The present disclosure is described with reference to the following drawings.

FIG. 1 is a schematic cross-sectional view of a composite film according to the invention,

FIG. 2 is a schematic cross-sectional view of a composite film according to the invention with an additional adhesion promoter layer,

FIG. 3 is a schematic cross-sectional view of a composite film according to the invention with a firmly bonded adhesion promoter,

FIG. 4 is a schematic cross-sectional view of a further composite film according to the invention with firmly bonded adhesion promoter

FIG. 5 is a schematic cross-sectional view of a composite film according to the invention with an additional protective layer,

FIG. 6 is a schematic cross-sectional view of a composite film according to the invention with an additional carrier layer,

FIG. 7 is a schematic cross-sectional view of a composite film according to the invention with a multilayer functional layer, and

FIG. 8 is a schematic cross-sectional view of a composite film according to the invention with adhesive zones on the film surfaces.

### DETAILED DISCLOSURE

Subject-matter of the present invention—according to a first aspect of the present invention—is a composite film, in particular for use in the construction sector and/or for use as a roof and/or facade membrane, having at least one carrier layer, wherein the carrier layer is configured as a non-woven layer, at least one protective layer, wherein the protective layer is composed on the basis of an acrylate- and/or polyurethane-based composition, and at least one functional layer, wherein the functional layer is arranged between the carrier layer and the protective layer, wherein the functional layer is configured as an at least single-layer membrane layer with a grammage of 50 g/m2 or less and contains thermoplastic polyurethane and/or thermoplastic copolyester elastomer, in particular consists thereof

Composite films according to the invention advantageously combine special durability, weather resistance and robustness with a weight-optimized, material- and resource-saving configuration. This is all the more remarkable as saving material, both in the carrier and functional layer as well as the protective layer, is regularly accompanied by a loss of performance that is difficult to compensate for. However, this can be overcome on the basis of the layer and material combination according to the invention.

According to the invention, it was surprisingly found that composite films according to the invention comprising functional layers with comparatively low surface weights, i.e. in a relatively thin configuration, have a property profile that can be rated as special and positive on the basis of the advantageous layer combination. In particular, composite films according to the invention are highly resistant to weathering and ageing, which is advantageously attributable to the combination and configuration of the protective layer and carrier layer. Composite films according to the invention are also characterized by very good moisture management properties, in that they are configured to be waterproof and airtight and at the same time reliably permeable to water vapor.

Furthermore, the mechanical as well as physical properties of composite films according to the invention are advantageously obtained reliably over a long period of time even under extreme weather conditions, i.e. high UV, wind and temperature exposure in combination with regular driving rain and the like, so that composite films according to the invention are overall ideally suited for long-term or long-term use in the construction sector.

Due to the material- and weight-optimized configuration, composite films according to the invention are also characterized by a cost efficiency that can be assessed as positive and, according to this aspect, are also to be assessed as advantageous compared to the state of the art.

With regard to the carrier layer, it has proven to be advantageous if the nonwoven layer is an at least single-layer, in particular a single-layer, spunbonded nonwoven. In this respect, the nonwoven layer can, for example, also comprise a two-layer or multi-layer spunbonded nonwoven.

Furthermore, it is preferred if the nonwoven layer comprises a polymeric material or a plastic material, in particular if it consists thereof.

Furthermore, it is well proven if the nonwoven layer, in particular the spunbonded nonwoven, comprises fibers of one or more components. According to the invention, it can thus be provided that the nonwoven layer comprises monocomponent fibers, bicomponent fibers and/or multicomponent fibers, in particular monocomponent fibers and/or bicomponent fibers.

According to the invention, a monocomponent fiber is to be understood as a fiber which is formed from one component, wherein the component essentially comprises only a polymeric material or a plastic material. The polymeric material or the plastic material may comprise, in addition to the polymer or plastic components, additional additives, in particular for setting material properties and in this sense also nonwoven properties.

According to the invention, a bicomponent fiber is understood to be a fiber comprising a first component and a second component, wherein the first component comprises a first polymeric material or plastic material and the second component comprises a second polymeric material or plastic material that differs from the first polymeric material or plastic material as a component. Again, the different polymeric materials or plastic materials may comprise, in addition to the polymeric or plastic components, additional additives, in particular for setting material properties and according to this also nonwoven properties. The differences between the polymeric materials or plastic materials that differ from each other can be achieved both on the basis of the use of different polymers and on the basis of the use of different additives; in this respect, it is the overall composition of the polymeric materials or plastic materials of the first or second component that is important in each case and not just the polymer used.

Finally, according to the invention, a multicomponent fiber is to be understood as a fiber which comprises at least three components each comprising at least one first, second and third polymeric material or plastic material which differ from each other. Again, the different polymeric materials or plastic materials may comprise, in addition to the polymer or plastic components, additional additives, in particular for setting material properties and, according to the invention, nonwoven properties. In addition, similar to the case of the bicomponent fiber, the differences between the polymeric materials or plastic materials that differ from each other can be achieved both on the basis of the use of different polymers and on the basis of the use of different additives. It is therefore the overall composition of the polymeric materials or plastic materials of the at least first, second and third components that is important in each case and not just the polymer used.

Similarly, it may be provided in the context of the present invention that the nonwoven layer comprises different fibers, i.e. fibers of different polymeric materials or plastic materials, for example is a staple fiber nonwoven or comprises several staple fiber nonwovens.

In the context of the present invention, it may thus be provided that the nonwoven layer comprises monocomponent fibers, bicomponent fibers and/or multicomponent fibers, in particular monocomponent fibers and/or bicomponent fibers, and/or different fibers made of different polymeric materials or plastic materials.

As far as the polymeric material or the plastic material of the nonwoven layer is concerned, it is well proven if the polymeric material of the nonwoven layer is selected from polyolefinic materials, polyester-based materials, thermoplastic polyurethane materials or mixtures thereof. Particularly good results are obtained in this context if the polymeric material of the nonwoven layer is selected from polyolefinic materials, thermoplastic polyurethane materials or mixtures thereof. Even more preferably, the polymeric material of the nonwoven layer is selected from polyolefins. Polyester-based materials ensure high strength, stability and/or tear resistance of the nonwoven.

It is well proven if the polyester-based material is selected from polymers of terephthalic acid, in particular copolymers of terephthalic acid, preferably polyethylene terephthalate. In particular, the use of polyolefinic materials in the carrier or non-woven layer makes it possible to achieve very good weathering stability.

Preferably, the polyolefinic material is selected from the group of polyolefin homopolymers, in particular polyethylene, polypropylene, polybutylene, polyhexylene, preferably polyethylene, polypropylene, more preferably polypropylene; polyolefin copolymers, in particular ethylene copolymers, propylene copolymers, butylene copolymers, hexylene copolymers, preferably ethylene copolymers, propylene copolymers, more preferably propylene copolymers, and mixtures thereof.

Particularly preferred, the polyolefinic material contains polypropylene, in particular consists of or is polypropylene.

The use of polymeric materials made of thermoplastic polyurethanes for producing the nonwoven layer is equally preferable due to their good clastic properties and certain ageing resistance. In addition, the use of thermoplastic polyurethanes in the nonwoven layer also allows a permanent adhesive-free bonding with the TPU functional layer, for example by extrusion application.

However, nonwovens made of thermoplastic polyurethanes have the disadvantage that they are significantly more cost-intensive to produce than polyester nonwovens or polyolefinic nonwovens. If thermoplastic aliphatic and/or aromatic polyurethanes are used in the context of the present invention for producing the nonwovens, it is usually envisaged that the thermoplastic polyurethane is selected from ether-type, polyester-type or carbonate-type polyurethane, preferably carbonate-type polyurethane.

The use of polyolefinic materials and thermoplastic polyurethane materials for producing the nonwovens results in much more flexible nonwovens and consequently also composite films than is possible with polyester-based materials, in particular PET nonwovens. In this way, even irregular shapes in a roof or façade can be well and permanently protected with the composite film according to the invention.

Similarly, it is also possible for the nonwoven to be made up of different fibers. In this case, it is preferably provided that the material of the fibers is selected from the aforementioned materials. In particular, nonwovens comprising fibers made of polyurethane and fibers made of polyolefins, in particular polypropylene, have special favorable properties.

Furthermore, the polymeric material or the plastic material of the nonwoven layer may contain additives. It is generally intended that the additives are regularly or evenly distributed in the polymeric phase or the polymeric material. In this sense, additives can also be understood as additives that are added to the polymer in the respective component in order to modify or improve the properties of the resulting fiber or the nonwoven or carrier layer as a whole.

Advantageously, the additives are primary or secondary antioxidants, UV absorbers, UV stabilizers, flame retardants, antistatic agents, lubricants, metal deactivators, hydrophilizing agents, hydrophobing agents, hydrolysis stabilizers, antifogging additives and/or biocides. The following substance classes and mixtures thereof are particularly preferred:
Sterically hindered phenols, aromatic secondary or tertiary amines, aminophenols, aromatic nitro or nitroso compounds as primary antioxidants.
Organic phosphites or phosphonates, thioethers, thioalcohols, thioesters, sulphides and sulphur-containing organic acids, dithiocarbamates, thiodipropionates, aminopyrazoles, metal-containing chelates, mercaptobenzimidazoles as secondary antioxidants.
Hydroxybenzophenones, cinnamates, oxalanilides, salicylates, 1,3 benzenediol monobenzoates, benzotriazoles, triazines, benzophenones and UV-absorbing pigments such as titanium dioxide or carbon black as UV absorbers.
Metal-containing complexes of organic sulphur or phosphorus compounds, sterically hindered amines (HALS) as UV stabilizers.
Metal hydroxides, borates, organic compounds containing bromine or chlorine, organic phosphorus compounds, antimony trioxide, melamine, melamine cyanurate, expandable graphite or other intumescent systems as flame retardants.
Quaternary ammonium salts, alkyl sulphonates, alkyl sulphates, alkyl phosphates, dithiocarbamates, (earth) alkali metal carboxylates, polyethylene glycols and their esters and ethers, fatty acid esters, ethoxylates, mono- and diglycerides, ethanolamines as antistatic agents.
Fatty alcohols, esters of fatty alcohols, fatty acids, fatty acid esters, dicarboxylic acid esters, fatty acid amides, metal salts of fatty acids, polyolefin waxes, natural or artificial kerosenes and their derivatives, fluoropolymers and fluoroligomers, antiblocking agents such as silicic acids, silicones, silicates, calcium carbonate etc. as lubricants.
Amides of mono- and dicarboxylic acids and their derivatives, cyclic amides, hydrazones and bishydrazones, hydrazides, hydrazines, melamine and its derivatives, benzotriazoles, aminotriazoles, sterically hindered phenols in compound with complexing metal compounds, benzylphosphonates, pyridithiols, thiobisphenol esters as metal deactivators.
Polyglycols, ethoxylates, fluoropolymers and fluoroligomers, montan waxes, in particular stearates, as hydrophilizing, hydrophobing or anti-fogging agents.
10,10′-oxybisphenoxarsine (OBPA), N-(trihalogen-methylthiol) phthalimide, tributyltin oxide, zinc dimethyldithiocarbamate, diphenylantimon-2-ethylhexanoate, copper-8-hydroxyquinoline, isothiazolones, silver and silver salts as biocides.

Advantageously, the mass fraction of the additives in the polymeric material or plastic material is at most 66.6 wt. %, in particular at most 50 wt. %, preferably at most 33.3 wt. %, based on the total composition of the polymeric material or plastic material.

If the nonwoven layer of the carrier layer now comprises fibers of a component or monocomponent fibers, it is preferably provided that the fiber is formed from a component, wherein the component essentially comprises only a polymeric material or a plastic material, wherein the polymeric material or the plastic material comprises one or more materials selected from the group of polyolefinic materials, polyester-based materials, thermoplastic polyurethane materials and mixtures thereof, in particular consisting thereof.

In the case where the nonwoven layer of the carrier layer comprises fibers of two components or bicomponent fibers, it is preferably if the fiber is formed of a first component and a second component, wherein the first component comprises a first polymeric material or plastic material and the second component comprises a second polymeric material or plastic material different from the first polymeric material or plastic material as a component, wherein the second component comprises a second polymeric material or plastic material different from the first polymeric material or plastic material as a component. plastic material as a component, wherein the first and/or the second polymeric material or plastic material of the first component and/or the second component comprises one or more materials selected from the group of polyolefinic materials, polyester-based materials, thermoplastic polyurethane materials and mixtures thereof, in particular consisting of these. The use of bicomponent fibers in the carrier layer can significantly increase the overall strength of the composite film, preferably by at least 10%, more preferably between 20% and 70%.

Particularly preferred, the first and/or the second polymeric material or plastic material of the first component and/or the second component comprises one or more polyolefinic materials, in particular consists of these.

Similarly, it may be provided that the polymeric material of the first components is selected from one or more polyolefinic materials and that the polymeric material of the second component is selected from thermoplastic polyurethane materials.

Further, in the case where the nonwoven layer of the carrier layer comprises fibers of two components or bicomponent fibers, it is preferably provided that the bicomponent fiber comprises at least substantially a core-sheath structure, in particular a core-sheath structure.

In the context of the present invention, bicomponent fibers comprising a core-sheath structure are understood to be fibers in which the second component surrounds and thus encloses the first component in the cross-section of the fiber. The use of such structured bicomponent fibers has the advantage that an optimal and reliably reproducible ratio of core component to sheath component can be set during the production of the fiber, so that in particular depending on the desired composition and desired properties of the bicomponent fiber, an individually or specifically composed fiber can be obtained. At the same time, the properties of the bicomponent fiber can be controlled in this way and, in particular, tuned to a specific application.

Furthermore, in the context of the present invention, it is preferably provided that the bicomponent fiber comprises a core formed from the first component and a sheath formed from the second component. Preferably, the core of the bicomponent fiber is thus formed from the first polymer and the cladding of the bicomponent fiber is formed from the second polymer.

As has already been mentioned, it is particularly preferred according to the invention if the first and/or the second polymeric material or plastic material of the first component and/or the second component comprises one or more polyolefinic materials, in particular consists thereof. In this case, it is well proven if the polymeric material or plastic material of one of the two components has been polymerized with a metallocene catalyst and the polymeric material or plastic material of the other component has been polymerized with a Ziegler-Natta catalyst and subjected to a subsequent visbreaking treatment. Advantageously, the polymeric, in particular polyolefinic, material or plastic material is polypropylene, polyethylene or a copolymer thereof or a mixture thereof. Such bicomponent fibers are comprehensively described in EP 2 826 898 A1, the content of which is hereby expressly referred to and the content of which is hereby fully included in the subject-matter of the present invention. Preferably metallocene catalysts according to the invention are described in detail, for example, in U.S. Pat. Nos. 5,374,696 and 5,064,802. Examples of visbreaking treatments suitable according to the invention are described in U.S. Pat. Nos. 4,282,076 and 5,723,217, among others.

Advantageously, the component whose polymeric material or plastic material has been polymerized with a metallocene catalyst forms the outer surface of the bicomponent fiber in the cross-section of the fiber. Particularly preferred is that the component whose polymeric material or plastic material has been polymerized with a metallocene catalyst completely surrounds the component whose polymer has been polymerized with a Ziegler-Natta catalyst, in particular.

Preferably, the mass fraction of the component whose polymeric material or plastic material has been polymerized with a metallocene catalyst in the bicomponent fiber is at most 50%, in particular at most 25%, preferably at most 10%, in particular at most 5%. The bicomponent fiber is particularly preferred to be a core-sheath fiber, wherein the component whose polymeric material or plastic material has been polymerized with a metallocene catalyst forms the sheath.

Advantageously, the difference between the melting points of the first component and the second component is less than or equal to 8° C. Further preferably, the difference between the melting points of the first component and the second component is at most 6° C., in particular between 1° C. and 8° C., preferably between 1° C. and 6° C.

Preferably, the component with the lower melting point forms the outer surface of the fiber in the cross-section of the fiber. Preferably, the component with the lower melting point surrounds the component with the higher melting point.

Preferably, the mass fraction of the component with the lower melting point in the bicomponent fiber is at most 50%, further in particular at most 25%, preferably at most 10%, in particular at most 5%. In this case, the bicomponent fiber is particularly preferred to be a core-sheath fiber, wherein the component with the lower melting point forms the sheath.

Also advantageously, the difference between the melt flow indices of the first component and the second component is less than or equal to 25 g/10 min, wherein the melt flow indices (hereinafter MFI) of the first component and the second component are each less than or equal to 50 g/10 min. Preferably, the difference between the Melt Flow Indices of the first component and the second component is less than or equal to 20 g/10 min, particularly preferred 15 g/10 min and/or the MFIs of the first component and the second component are each less than or equal to 40 g/10 min.

In the context of the present invention, the MFI is measured according to ISO 1133 with a test load of 2.16 kg and at a test temperature of 230° C. The material is melted in a heatable cylinder and forced through a defined nozzle using the test load.

Preferably, the mass fraction of the component with the higher MFI in the bicomponent fiber is at most 50%, in particular at most 25%, preferably at most 10%, in particular at most 5%. In this case, the bicomponent fiber is particularly preferred to be a core-sheath fiber, wherein the component with the higher MFI forms the sheath.

If the bicomponent fiber contains a material of thermoplastic polyurethane, the material of thermoplastic polyurethane usually configures the second component, i.e. the sheath. The core is then preferably formed from a polyolefinic material.

In the preferred case that the bicomponent fiber is a core-sheath fiber, it is particularly well proven if the mass fraction of the core is 50% to 98%, in particular 60% to 95%, preferably 70% to 95%, more preferably 80% to 90%.

If the bicomponent fiber is a side-by-side fiber, segmented-pie fiber or islands-in-the-sea fiber, the mass ratio of the two components is advantageously in the range from 10:90 to 90:10, in particular in the range from 70:30 to 30:70, preferably in the range from 60:40 to 40:60.

In another preferred embodiment, the bicomponent fiber is a multilobal, in particular a tetralobal or trilobal fiber. Due to their cross-sectional geometry, these fibers offer a higher specific surface area than comparable fibers with circular cross-sections.

In general, it is also well proven if the diameter of the fibers of the nonwoven layer is between 1 and 50 μm, in particular between 5 and 30 μm, preferably between 8 and 20 μm.

As regards the carrier layer or nonwoven layer in general, it is well proven if the carrier layer comprises a grammage in the range from 50 to 250 g/m2, in particular from 80 to 180 g/m2, preferably from 100 and 150 g/m2.

The carrier layer of the composite film is also preferably, in particular mechanically, chemically and/or thermally, preferably thermally, strengthened, wherein the strength is increased by up to 20% compared to carrier or non-woven layers known from the prior art. Particularly preferred, the carrier layer comprises a high resistance to mechanical loads, for example when the composite film is used as a roofing membrane, in particular when roofers walk on it. Alternatively or additionally, according to the invention, the formation of lint or the tendency to form lint and/or possibly the occurrence of cracks and/or holes in the carrier layer and/or the composite film as a whole can be very low, in particular under mechanical stress. The very good abrasion resistance of the polymeric materials used is a special advantage in this respect. As far as the protective layer of the composite film according to the invention is concerned, it advantageously serves to protect the composite film from UV radiation and to protect the thin functional layer from mechanical damage.

In the installed state, i.e. for example when using the composite film according to the invention as a roof or facade membrane, there is an outward-facing weathering side and an inner side facing the roof or facade construction. UV radiation from the incoming sunlight largely acts on the outward-facing weathering side, so that according to the invention the protective layer is preferably provided on the weathering side as the outer or external layer of the composite film in order to protect the other layers of the composite film from UV radiation.

Depending on the nature of the roof construction and the respective installation situation, it is also possible that UV radiation can penetrate from the inside of this layer to the sub-roof membrane. This can be effected, for example, through cut-outs for roof windows or similar. This can also result in localized damage to the under-roof membrane at the points exposed to UV radiation from the inside. To counter this problem, it has proven to be advantageous, among other things, to apply a protective layer to the inside of the composite film facing the roof or facade construction in an under-roof membrane according to the invention.

Since, as a rule, the majority of the UV radiation will act on the composite sheet from the outside, i.e. from the weathering side, a protective layer on the inside is preferably provided as an additional layer, in particular in addition to an existing protective layer on the weathering side of the composite sheet facing outwards. Furthermore, special installation situations are also conceivable in which it is appropriate to apply a protective layer only on the inside of the under-roof membrane and to dispense with a protective layer on the weathering side. It is understood that such an embodiment is also covered by the present invention.

As far as the protective layer is concerned, it preferably comprises or consists of an acrylate and/or a polyurethane. Preferably, the protective layer comprises an acrylate or a polyurethane.

If the protective layer comprises an acrylate and/or a polyurethane, this means in the context of the present invention that the polymer of the protective layer is an acrylate and/or a polyurethane. In addition to the polymer, the protective layer may of course contain other components, such as filler or additives. If the protective layer comprises an acrylate and/or a polyurethane, this means in the context of the present invention that the polymeric material of the protective layer comprises an acrylate and/or a polyurethane, i.e. the polymeric material of the protective layer may comprise further polymers.

Particularly good results are obtained in the context of the present invention if the protective layer comprises or consists of an acrylate, in particular consists of this.

In particular, the protective layer may be foamed or unfoamed.

As far as a preferred configuration of the protective layer is concerned, it is well proven here if the protective layer is configured as a foam layer, in particular a microporous foam layer. Likewise, in a preferred embodiment of the composite film according to the invention, the protective layer is present as an open-cell foam or comprises a microporous and/or open-cell foam.

In contrast to a closed-cell form foam, the three-dimensional, net-like structure of a microporous, open-cell foam allows water vapor to flow through to a high degree. At the same time, the tortuous passages present in the microporous, open-cell foam due to its structure prevent the linear passage of UV rays, resulting in very effective protection against UV radiation.

In this way, it is also advantageously ensured that the protective layer is configured to be permeable to water vapor. Preferably, the protective layer comprises a greater water vapour permeability than the functional layer, in particular in order not to impair the Sd value intended for the under-roof membrane and realized by the functional layer.

In this respect, it has proven to be advantageous if the ratio of the Sd value of the functional layer to the Sd value of the protective layer is in particular greater than or equal to 2:1, preferably greater than or equal to 5:1, more preferably greater than or equal to 10:1, more preferably greater than or equal to 20:1, more preferably greater than or equal to 30:1, particularly preferred greater than or equal to 40:1, in particular greater than or equal to 50:1.

According to the invention, it is usually provided that the protective layer is configured to be permeable to water vapor and also to water. Any water penetrating into the protective layer must not or only insignificantly impair the flow of water vapor through the protective layer.

Preferably, the protective layer according to this embodiment is free of hydrophobizing agents. It is a special feature of the present invention that an acrylate-based protective layer can also be free of hydrophobizing agents, since the water-tightness of the composite film is ensured by the functional layer arranged between the protective layer and the non-woven layer. In this way, it is possible within the scope of the present invention to dispense with hydrophobizing agents, which are highly problematic for reasons of environmental and health protection.

However, it may also be envisaged that the protective layer is configured as a waterproof layer. In this configuration, the protective layer then contributes to protecting the roof structure from the penetration of moisture and dirt in the same way as the functional layer. Preferably, however, the protective layer is configured to be water-permeable.

It is generally well proven in the context of the present invention if the protective layer comprises a grammage in the range from 20 to 250 g/m2, in particular from 40 to 160 g/m2, preferably from 60 to 130 g/m2. According to the invention, the aforementioned grammages can be advantageously achieved if the protective layer is applied as a foam coating. It is also possible to apply the protective layer to the other layers of the composite film according to the invention using coextrusion or as a paste coating.

As already mentioned, an acrylate- and/or polyurethane-based composition, in particular an acrylate-based composition, is used as the material for forming the protective layer. Preferably, the acrylate- and/or polyurethane-based composition is present as a dispersion, in particular a highly filled dispersion.

In the context of the present invention, a dispersion is to be understood as an at least two-phase system, wherein a first phase, the dispersed phase, is present dispersed in a second phase, the continuous phase. The continuous phase is also called dispersion medium or dispersant. In particular in the case of polymeric compounds, the transition from a solution to a dispersion is often fluid, so that it is no longer possible to clearly distinguish between a solution and a dispersion.

In the context of the present invention, it is preferred if the dispersion is present as an aqueous dispersion, i.e. the dispersion medium is water.

According to the invention, it has further been found to be advantageous with respect to the composition used if the composition, in particular as a, preferably highly filled, dispersion comprises a polymer or plastic content of 25% or more, in particular 35% or more, preferably 45% or more, based on the total composition. The polymer or plastic content means, in particular, the acrylate and/or polyurethane base on which the composition is based.

With regard to the acrylate base in particular, it has proven well if the acrylate of the acrylate base is selected from acrylic acid esters, methacrylic acid esters and mixtures thereof.

Special good results are achieved if methacrylates, butyl acrylates, allyl methacrylates, ethyl acrylates and/or polyacrylates are used as acrylates.

Furthermore, it is also usually envisaged that the acrylate- and/or polyurethane-based composition comprises additives, wherein the additives are selected from the group consisting of antioxidants, UV absorbers, UV stabilizers, colorants, flame retardants, antistatic agents, lubricants, metal deactivators, hydrophilizing agents, hydrophobizing agents, antifogging additives, biocides and mixtures thereof. Preferably, the acrylate and/or polyurethane-based composition comprises UV absorbers, UV stabilizers, flame retardants, antioxidants and/or stabilizers.

However, as explained above, it is preferred within the scope of the present invention if the protective layer is free of hydrophobizing agents.

In the context of the present invention, however, it is envisaged that the protective layer comprises flame retardants. If the protective layer includes flame retardants, the flame retardants are typically selected from the group consisting of antimony trioxide, metal hydroxides, borates, organic bromine or chlorine containing compounds, organic phosphorus compounds, melamine, melamine cyanurate, expandable graphite or other intumescent systems and mixtures thereof.

It is particularly preferred in the context of the present invention if the protective layer comprises expandable graphite as a flame retardant. By using expandable graphite as a flame retardant in the protective layer, it is possible on the one hand to avoid the use of problematic substances, in particular organic phosphorus compounds, borates, antimony trioxide or also organic bromine- or chlorine-containing compounds, the use of which should be avoided. On the other hand, it is possible that the composite film comprises a fire behavior according to DIN EN 13501-1 class B and is therefore flame retardant due to the use of expandable graphite.

Good results are obtained here if the additives are contained in the acrylate- and/or polyurethane-based composition in total in quantities in a range from 5 to 20 wt. %, in particular 10 to 15 wt. %, preferably 11 to 13 wt. %, based on the total composition.

Advantageously, the protective layer is configured to be sufficiently abrasion-resistant so that the watertightness of the composite film is obtained at least to a sufficient degree even after mechanical stress. The abrasion resistance is determined according to DIN CERTCO “Certification program for under-roof membranes according to DIN EN 13859-1” or DIN EN ISO 12947-2. Sufficient abrasion resistance is achieved if the water resistance according to DIN EN 20811 of a test specimen after an abrasion load in a Martindale device is still at least 1500 mmWS at a water pressure increase of 60±3 cmWS/min.

As far as the functional layer of the composite film according to the invention is concerned, it is preferably configured as a monolithic membrane layer.

According to the invention, a monolithic membrane layer is understood to be such a membrane layer which is configured to be non-porous, i.e. the membrane has no pores. According to the invention, water vapor transport through monolithic membranes takes place according to the following mechanism:
1. adsorption, i.e. uptake and physical binding of water molecules to the membrane surface,
2. absorption, i.e. the penetration of water molecules into membranes,
3. diffusion, i.e. transport of water molecules through the membrane and
4. desorption, i.e. release of the water molecules into the gas space.

According to the invention, the functional layer contains thermoplastic polyurethane and/or thermoplastic copolyester elastomer, preferably thermoplastic polyurethane.

Thermoplastic polyurethane is characterized in particular by its intrinsic flame-retardant effect and good long-term aging behavior, preferably for service lives of more than 10 years.

In particular, thermoplastic polyurethanes show significantly improved long-term operational reliability in the context of use as a functional layer of a multilayer film for the construction sector. These include
significantly higher hydrolysis resistance,
significantly higher chemical resistance,
significantly better resistance to ageing at high temperatures,
improved weathering resistance and
higher abrasion resistance.

From these properties, it can be deduced that the use of thermoplastic polyurethanes can reduce the grammage of the monolithic functional film without
reducing the operational safety compared to previous films used in the construction sector,
disregarding official requirements with regard to the fire protection standard to be met.

In particular, this results in a resource- and cost-saving configuration of a multilayer film.

Thermoplastic copolyester elastomer corresponds to thermoplastic polyurethane in many properties and applications, although the ageing resistance of thermoplastic copolyester elastomer is lower than that of thermoplastic polyurethane. Despite its lower ageing resistance, thermoplastic copolyester elastomer is excellently suited to producing membranes or functional layers of composite films, in particular for the construction sector.

In general, a thermoplastic polyurethane in the context of the present invention is to be understood as a thermoplastic elastomer which is formed from polyurethane. Thermoplastic polyurethane is also referred to as TPU.

In the context of the invention, a thermoplastic copolyester elastomer, also referred to synonymously as a polyether polyester, is to be understood as a thermoplastic elastomer which is composed of polyether and polyester segments. Thermoplastic copolyester elastomer is also referred to as TPC.

Thermoplastic elastomers are plastics which exhibit elastomeric behavior at room temperature but thermoplastic behavior when heat is applied. A special advantage of thermoplastic elastomers is that, compared to pure elastomers, they can be reversibly deformed at any time under the influence of heat. Thermoplastic polyurethane and thermoplastic copolyester elastomers in particular are block copolymers that are made up of elastomer segments, known as soft segments, and thermoplastic segments, known as hard segments.

The use of thermoplastic polyurethane in the functional layer of the composite construction film according to the invention is preferred.

It has been found to be advantageous in the context of the present invention if the thermoplastic polyurethane of the functional layer is selected from the group of aliphatic and/or aromatic polyurethanes, in particular of the ether type, the ester type, the carbonate type, and mixtures thereof, in particular of the aliphatic and/or aromatic polyurethanes of the carbonate type, preferably the aromatic polyurethanes of the ether type and/or the carbonate type.

In particular, the targeted combination of aromatic polyurethanes can provide waterproof but diffusion-open monolithic membranes which comprise excellent weathering properties, are mechanically resistant and resistant to chemicals, have a flame-retardant effect and are accessible at low cost.

As previously explained, thermoplastic polyurethanes are polyurethanes that have a hard segment and a soft segment. The soft segment is usually formed by an oligomeric or polymeric polyol and the hard segment consists of a diisocyanate comprising short-chain diols as chain extenders.

Short-chain bifunctional substances, in particular diols, whose molecular weight is usually between 18 and 350 g/mol are used as chain extenders. Preferably, short-chain diols are used as chain extenders. Typically, the chain extenders are divalent alcohols, in particular selected from the group of 1,2-ethanediol, 1,2-propanediol, 1,4-butanediol, 2,3-butanediol, 1,5-pentanediol, 1,6-hexanediol, 1,8-octanediol, diethylene glycol, triethylene glycol, tetraethylene glycol and higher oligoethylene glycols, dipropylene glycol and higher oligopropylene glycols, dibutylene glycol, higher oligoethylene glycols and mixtures thereof.

In the context of the present invention, an aliphatic or aromatic polyurethane is to be understood as a polyurethane whose hard segment contains aliphatic or aromatic diisocyanates or is obtained from these by reacting with the chain extenders.

The aromatic diisocyanates are preferably TDI (toluene 2,4-diisocyanate), NDI (naphthylene 1,5-diisocyanate), MDI (methylene di(phenyl isocyanate), PDI (polymeric diphenylmethane diisocyanate) or mixtures thereof.

Aliphatic diisocyanates are preferably selected from H12MDI (1-isocyanato-4-[(4-isocyanotocyclohexyl)methyl]cyclohexane), HDI (1,6-hexa-methy¬lene diisocyanate), IPDI (3-isocyanate methyl 3,5,5-trimethylcyclohexyl isocyanate), TMXDI (tetramethylxylyl diisocyanate) and CHDI (1,4-cylcohexyl diisocyanate) and mixtures thereof.

In the context of the present invention, an ether-type thermoplastic polyurethane or an ether TPU is to be understood as a thermoplastic polyurethane whose soft segment is composed of polyethers. These polyethers are preferably obtainable from polyether alcohols, in particular with hydroxy functionality 2, i.e. from diols. The polyether alcohols, in particular the polyether diols, are usually obtained by polymerization of short-chain precursors, in particular, for example, by anionic polymerization with alkali metal hydroxides, such as sodium or potassium hydroxide, or alkali metal alcoholates, such as sodium methylate, sodium or potassium ethylate or potassium isopropylate as catalysts or by cationic polymerization with Lewis acids, such as antimony pentachloride, borofluid etherate, as catalysts from one or more alkylene oxides or cyclic ethers with preferably 2 to 4 carbon atoms in the alkylene radical. Particularly suitable compounds for polymerization are, for example, tetrahydrofuran, 1,3-propylene oxide, 1,2- and 2,3-butylene oxide, 1,4-butylene oxide, ethylene oxide and 1,2-propylene oxide. The alkylene oxides can be used individually, alternately or as a mixture during polymerization.

Depending on the number of carbon atoms in the chain between the ether functionalities of the alkylene radical, the thermoplastic ether polyurethanes are subdivided, wherein C2-ether polyurethanes, C3-ether polyurethanes and C4-ether polyurethanes are the most widely used. C2-ether polyurethanes are obtainable, for example, by polymerization of ethylene oxide, 1,2-propylene oxide, 1,2- and 2,3-butylene oxide. C3-ether polyurethanes are obtainable, for example, by polymerization of 1,3-propylene oxide. C4-ether polyurethanes are obtainable by polymerization of 1,4-butylene oxide.

If an ether-type polyurethane is used in the context of the present invention, the ether-type polyurethane is usually selected from C2- to C4-ether TPUs, in particular C2- and/or C3-ether TPUs or C4-ether TPUs.

In the context of the present invention, a polyester-type thermoplastic polyurethane or a polyester TPU is to be understood as a thermoplastic polyurethane whose soft segment is formed from polyester polyols, in particular polyester diols.

In the context of the present invention, an ether-ester type thermoplastic polyurethane or an ether-ester TPU is a polyurethane whose soft segment is formed from polyethers or oligoethers and polyesters.

In the context of the present invention, a thermoplastic polyurethane of the carbonate type or a carbonate TPU is formed by a polyol, in particular a diol, which comprises a structural element of a carbonic acid diester.

A large number of thermoplastic polyurethanes are commonly used in the prior art and in particular in the construction sector, each comprising the following properties.

Aromatic ester TPUs and aromatic ether ester TPUs are sensitive to hydrolysis and comprise only moderate weathering properties. However, they have an inherent flame-retardant effect and good mechanical properties, such as low tear resistance and high abrasion resistance.

Aromatic C4-ether TPUs also comprise moderate weathering properties, but are not sensitive to hydrolysis and have inherent flame retardant properties. Aromatic C4-ether TPUs are frequently found in roof underlays.

Aromatic C2- and/or C3-ether TPUs are the least expensive thermoplastic polyurethanes. They are not sensitive to hydrolysis and have inherent flame-retardant properties. However, their weathering properties are not satisfactory, so that construction films for outdoor applications are not usually based on C2- or C3-ether TPUs.

Aromatic carbonate TPUs have an excellent inherent flame-retardant effect as well as very good weathering stability and are also highly resistant to hydrolysis and heat storage. However, aromatic carbonate TPUs are cost-intensive to produce, which is why they have so far only been used occasionally in special applications.

Finally, aliphatic TPUs have excellent weathering resistance and do not yellow when exposed to light. However, they do not comprise any inherent flame-retardant effect, have a high tendency to swell when absorbing water and are also extremely cost-intensive. Due to these disadvantages, aliphatic TPUs have hardly ever been used in the construction sector.

Through the use of a protective layer that protects the functional layer of thermoplastic polyurethane and/or thermoplastic copolyester elastomer, preferably thermoplastic polyurethane, from mechanical stress and UV radiation, it is possible to obtain extremely resistant and ageing-stable composite construction films with a thin functional layer of thermoplastic polyurethane and/or thermoplastic copolyester elastomer, preferably thermoplastic polyurethane.

The thermoplastic polyurethane and/or thermoplastic copolyester elastomer, preferably thermoplastic polyurethane, of the functional layer may also contain additives. It is generally provided that the additives are regularly or uniformly distributed in the thermoplastic polyurethane and/or thermoplastic copolyester elastomer, preferably thermoplastic polyurethane. Advantageously, the additives are primary or secondary antioxidants, UV absorbers, UV stabilizers, flame retardants, antistatic agents, lubricants, metal deactivators, hydrophilizing agents, hydrophobing agents, antifogging additives and/or biocides, as can also be used in the carrier layer.

It is further advantageously provided in the context of the present invention that the functional layer comprises a grammage of 40 g/m2 or less, in particular 30 g/m2 or less, particularly preferred 25 g/m2 or less.

Particularly preferred is that the functional layer comprises a grammage in the range from 5 to 50 g/m2, in particular from 10 to 40 g/m2, preferably from 15 to 30 g/m2, more preferably from 20 to 25 g/m2. Composite films according to the invention can thus comprise functional layers with particularly thin grammages compared to conventional composite films, which overall advantageously contributes to a weight-optimized and material-saving configuration of the composite film.

In the context of a particularly preferred embodiment of the present invention, it may be provided that the functional layer is configured as a multilayer film, in particular comprising a first and a second layer, preferably comprising a first and a second layer in the form of monolithic layers.

Preferably, the first and the second layer of the multilayer film thereby contain thermoplastic polyurethane and/or thermoplastic copolyester elastomer, preferably thermoplastic polyurethane, in particular wherein the thermoplastic polyurethane or the thermoplastic copolyester elastomer of the first layer and the thermoplastic polyurethane or the thermoplastic copolyester elastomer of the second layer are different thermoplastic polyurethanes or the thermoplastic copolyester elastomers. The differences between the thermoplastic polyurethanes or thermoplastic copolyester elastomers differing from each other can be achieved both on the basis of the use of different polyurethanes or thermoplastic copolyester elastomers and on the basis of the use of different additives; in this respect, it is in each case the overall composition of the thermoplastic polyurethanes or thermoplastic copolyester elastomers of the first or second layer that is important and not merely the polymer used. By using different thermoplastic materials, for example different thermoplastic polyurethanes or different thermoplastic copolyester elastomers or also thermoplastic polyurethane and thermoplastic copolyester elastomer in different layers, a concentration gradient for water in the membrane can preferably be set, for example, which favors and promotes the transport of water vapor in one direction, so that preferably only a transport of water vapor from a building to the environment is effected and not vice versa.

According to a further preferred embodiment of the present invention, it may be provided that the composite film comprises an adhesion promoter layer. Preferably, the adhesion promoter layer is arranged between the carrier layer and the functional layer and/or between the functional layer and the protective layer.

In the context of the present invention, it is preferably provided that the adhesion promoter layer is arranged between the carrier layer and the functional layer. On the one hand, the use of an adhesion promoter layer makes it possible to bond a large number of different functional layers and carrier materials, in particular nonwovens, which are not compatible in terms of their surface properties. In addition, the adhesive application also improves the mechanical properties of the resulting film compared to an extrusion coating.

In particular, the adhesion promoter layer can be configured as an adhesive layer and/or the adhesion promoter can be configured as an adhesive. Preferably, the adhesion promoter layer and/or the adhesive layer enables material bonding of the layers to be joined with each other.

The adhesion promoter layer may further comprise a polymer, in particular an adhesion promoter polymer. The adhesion promoter layer can be firmly bonded with the functional layer, the carrier layer and/or the protective layer. The adhesion promoter layer and/or the adhesion promoter polymer may advantageously comprise a plastic and/or a synthetic resin, preferably a polyurethane. Preferably, the adhesion promoter layer comprises or consists of an adhesive, in particular a reactive adhesive. Particularly preferred, the adhesion promoter layer and/or the adhesion promoter polymer comprises a reactive hot-melt adhesive, in particular a polyurethane hot-melt, in particular consists of this.

Preferably, the adhesion promoter layer also comprises a grammage in the range from 1 to 15 g/m2, in particular from 2 to 10 g/m2, preferably from 3 to 7 g/m2.

In the context of the present invention, it is usually envisaged that the adhesion promoter layer is applied to the non-woven layer using roller application, nozzle application, spray application, scatter application or the like.

The composite film according to the invention as a whole is preferably configured to be diffusion-open, windproof and/or rainproof, in particular waterproof, and/or water-repellent and/or water-vapor-permeable. The rainproofness and/or watertightness and/or water vapor permeability can be achieved and ensured in particular by the functional layer, which is preferably open to diffusion, wherein the functional layer is configured such that the composite film as a whole is permeable to water vapor and/or open to diffusion and/or watertight, in particular permeable to water vapor and watertight.

In the case of a rainproof and/or watertight configuration of the composite film, it is provided in particular that the latter can withstand a water column of greater than 2,000 mm, in particular between 3,000 mm and 30,000 mm, preferably between 5,000 mm and 20,000 mm. The water column is a unit of measurement that indicates the waterproofness of technical fabrics. It can be determined according to DIN EN ISO 811:2018-08 (as of September 2018).

Preferably, the composite film also comprises an Sd value of less than or equal to 0.5 m, in particular from 0.05 m to 0.5 m, preferably from 0.08 m to 0.2 m, more preferably from 0.09 m to 0.15 m. The Sd value indicates the water vapor diffusion equivalent air layer thickness and is a building physics measure for the water vapor diffusion resistance of a component or a component layer. The vapor permeability of a building material can be assessed using the sd value. The water vapor diffusion resistance is clearly described by the thickness of an air layer that is necessary so that the same diffusion flow—as the component under consideration—flows through the air layer in a stationary state under the same conditions. In particular, the composite film is configured to be open to diffusion, wherein the diffusion openness is characterized by an sd value of less than or equal to 0.5 m.

In the context of the present invention, the composite film is thus both highly waterproof and permeable to water vapor, so that on the one hand liquid water, in particular rain or melting snow, is prevented from penetrating a building structure, but on the other hand moisture from the interior can diffuse through the composite film and be released into the environment.

According to a preferred embodiment of the present invention, the composite film is also configured to be airtight. In this context, particularly good results are obtained if the multilayer film comprises an air permeability according to DIN EN 12114 at 50 Pa pressure difference of less than 0.1 m3/(m2 h), in particular 0.01 m3/(m2 h), preferably 0.005 m3/(m2 h), more preferably 0.001 m3/(m2 h). Films with the aforementioned air permeability can be used for producing airtight layers in buildings, in particular in roof structures.

In the context of the present invention, it is further preferred if the composite film is hydrolytically stable. In the context of the present invention, the term “hydrolytically stable” with respect to a film means that the elongation at break of the film after storage for 12 weeks at 70° C. and 90% humidity is at least 80% of the initial value.

In accordance with the invention, the composite film also comprises very good weathering stability, in particular due to the protective layer provided, and at the same time high UV stability. The composite film can thus be used for a longer period of time, wherein it can at least essentially guarantee the required weathering properties over this period. In particular, the composite film has a service life of longer than 10 years, preferably between 15 and 60 years.

According to the invention, it is also preferable if the tear resistance or tear force of composite films according to the invention is at least 300 N/5 cm in the machine direction and/or at least 200 N/5 cm in the cross direction, in particular 350 N/5 cm in the machine direction and/or at least 250 N/5 cm in the cross direction, preferably at least 375 N/5 cm in the machine direction and/or at least 275 N/5 cm in the cross direction, particularly preferred at least 400 N/5 cm in the machine direction and/or at least 300 N/5 cm in the cross direction. The tensile strength of the composite film can correspond to the force required until cracking and/or crack expansion. In particular, the tear strength is measured according to the ASTM International technical standard, namely ASTM D1004 (as of September 2018) and ASTM D1925 (as of September 2018).

It is also advantageous if the elongation at break of composite films according to the invention is at least 40% in the machine direction and/or at least 50% in the cross direction, in particular 45% in the machine direction and/or at least 60% in the cross direction, preferably at least 50% in the machine direction and/or at least 70% in the cross direction, particularly preferred at least 55% in the machine direction and/or at least 75% in the cross direction. The elongation at break is also measured according to ASTM D1004 (as of September 2018) and ASTM D1925 (as of September 2018).

The machine direction refers to the direction in which the composite film was transported in or through the machine when it was produced, i.e. regularly the longitudinal direction of a film web. The cross direction, in which the composite film expands over its surface, refers to the direction at right angles to the machine direction, i.e. regularly the direction in the width of a film web.

Preferably, the specific nail pull-out force of composite films according to the invention is at least 120 N in the machine direction and/or at least 150 N in the cross direction, in particular at least 140 N in the machine direction and/or at least 165 N in the cross direction, preferably at least 160 N in the machine direction and/or at least 180 N in the cross direction.

The specific nail pull-out force is the maximum force that occurs when a film strip is torn if the film strip already comprises a given damage, namely a nail pushed through the composite film. The specific nail pull-out force is measured in accordance with EN 12310-1.

The combination of these advantageous minimum parameters results in a composite film that is suitable for a wide range of applications in terms of its mechanical properties. Such a film can be used well in the construction sector, for example, where it must often be possible to fasten the film webs by nailing, stapling or screwing. In particular, the composite film according to the present invention does not tear or tear off if it is attached to a roof, for example.

In practice, a high specific nail tear resistance is also often accompanied by a good feel. The reason for the good feel is the high mobility of individual fibers, which is regularly associated with the occurrence of high nail pull-out forces. In practice, fibers that behave in this way also regularly comprise haptic properties that are perceived as soft and pleasant. The fiber segment mobility allows fibers to “collect” in the nail as the nail moves through the fleece by evading the nail moving through the fleece and not tearing immediately. This leads to a zone of increased fiber density, i.e. a zone of increased strength, around the nail.

In the context of an embodiment of composite films according to the invention, it may be provided that at least one reinforcing layer is arranged between the functional layer and the carrier layer and/or the protective layer. In particular, a reinforcing layer may be arranged between the carrier layer and the functional layer and between the protective layer and the functional layer. The reinforcing layer can be configured as a leno fabric or multifilament fabric. The reinforcing layer serves in particular to increase the mechanical stability of the composite film. This embodiment is possible, but not preferably, as the structure of the carrier layer, functional layer and protective layer usually already ensures sufficient strength and stability of the composite film.

Leno fabrics are transparent and/or air-permeable fabrics that are characterized by special warp threads. The warp threads configure the so-called leno units, in which a base thread and a loop thread from the warp twist with each other. In particular, the fabric comprises a low grammage. By firmly enclosing the weft threads from the two warp threads, a sliding strength can be ensured. Preferably, the reinforcing layer is formed from polypropylene and/or polyethylene terephthalate (PET).

In the context of the present invention, according to a preferred embodiment, it is provided that the composite film comprises an ageing stability of at least 15 years, wherein the ageing stability is determined by subjecting the composite film to an artificial ageing process, wherein the artificial ageing process is carried out at a temperature of 70±2° C. and an air velocity of 5±2 m/s, and wherein, following the artificial ageing process, the watertightness of the composite film is tested according to DIN EN 13859-1-2010-11, section 5. 2.3, against a water column of at least 200 mm over a period of 2 hours.

Particularly good results are obtained in this context if the composite film comprises an ageing stability of at least 20 years, in particular at least 25 years.

To determine the ageing stability, the artificial ageing process is usually carried out over a period of at least 30 weeks, in particular at least 36 weeks, preferably at least 48 weeks.

In a further preferred embodiment of the composite film according to the invention, at least one longitudinal edge-side adhesive zone is provided on the surfaces, in particular the top side and/or the bottom side, of the composite film. The longitudinal edge-side adhesive zone is used for bonding proximity composite films to produce a coherent film layer consisting of individual composite film strips. Advantageously, the adhesive zone on the longitudinal edge is spaced from the longitudinal edge of the composite film. Furthermore, the adhesive zone can be configured in strips, possibly in the form of interrupted strips.

It is well proven if the adhesive zone comprises a width of between 2 and 10 cm.

Further preferably, an adhesive-free area on the surfaces, in particular the top side and/or the bottom side, of the composite film of greater than 50%, in particular between 50% and 95%, preferably between 80% and 90%, is provided. An adhesive-free or adhesive-free area indicates the portion of the surface of the laminated film that is not covered by an adhesive zone. Ultimately, the adhesive zone is therefore provided on the longitudinal edge of the top and/or bottom side.

It is understood that the composite film may comprise one adhesive zone, two adhesive zones and/or a plurality of adhesive zones, for example four adhesive zones. In particular, it may be provided that at least one longitudinal edge-side adhesive zone is provided on the surfaces, in particular the top side and/or the bottom side, of the composite film.

Alternatively, two edge-side adhesive zones may be provided on the surfaces, in particular the top side or the bottom side, of the composite film. In a further embodiment, one adhesive zone is provided in the region of each of the four longitudinal edges of the composite film, so that the composite film comprises four adhesive zones.

Preferably, the adhesive zones are between 1 and 90 mm from the longitudinal edge, in particular between 3 and 70 mm, preferably between 5 and 50 mm.

In particular, a strip-shaped configuration of the adhesive zones can enable a clean and simple arrangement of the sheets on top of each other, especially in the case of an adhesive-in-adhesive compound. If the adhesive zones are configured in strips, it is envisaged that the number of strips in particular is between 1 and 15, preferably between 3 and 12, more preferably between 5 and 9. The strip width of a strip of the adhesive zone can in particular be between 1 to 30 mm, more preferably between 1.5 to 10 mm, more preferably between 2 to 5 mm.

Preferably, the bonding of the bonding zones is effected in such a way that when a proximity composite film is bonded, a windproof and/or airtight bond is achieved between the two composite films. In particular, this means that no wind can penetrate between the bonded areas. In particular, an adhesive-in-adhesive compound is effected, i.e. the adhesive zones are arranged one above the other, at least in certain areas, in such a way that the rows of composite films are firmly and permanently bonded. In this context, it is understood that the adhesive zones can be configured identically and/or comprise properties that differ from each other.

In addition, the offset of the top and bottom adhesive zones from a longitudinal edge of the composite sheet can be provided in such a way that, when sheets in proximity are bonded, only a partial adhesive-in-adhesive compound is formed between the adhesive zones of adjacent composite sheets, or even no such compound is formed. As explained above, the adhesive-in-adhesive compound enables windproof, airtight, diffusion-open and/or waterproof bonding of the composite film. This means that the required properties of the composite film can also be adequately guaranteed in the transition areas of the composite film, in particular the longitudinal edge area, preferably when laid on a pitched roof.

In a further preferred embodiment of the invention, it is provided that the mating surface for the adhesive zone comprising the adhesive is covered and/or surface-treated with a liner, in particular in the form of a peel-off strip. By covering the adhesive or the adhesive zones, it can be ensured that there is no contamination of the adhesive zone when the composite film is laid or that the degree of contamination is kept as low as possible. Consequently, a windproof and/or waterproof bond can be produced, preferably via an adhesive-in-adhesive compound.

Based on the aforementioned advantageous properties that composite films according to the invention can comprise, these are excellently suited in particular for use as a roof and/or facade membrane, in particular as a roof underlay membrane, underlay membrane or facade membrane.

According to a preferred embodiment of the present invention, it can also be provided that the composite film is configured as a roof and/or facade membrane, in particular as a roof underlayment membrane, sarking membrane or facade membrane.

A further subject-matter of the present invention—according to a second aspect of the present invention—is the use of a composite film according to the invention in the construction sector, in particular as a roof and/or facade membrane, in particular as a roof underlay membrane, underlay membrane or facade membrane.

For further details of the use according to the invention, reference can be made to the above explanations of the composite film according to the invention, which apply correspondingly to the use according to the invention.

Further subject-matter of the present invention—according to a third aspect of the present invention—is a method for producing a composite film as described above, wherein
(a) in a first method step, a carrier layer (4), wherein the carrier layer (4) is configured as a nonwoven layer, is loaded, in particular laminated, with a functional layer (5), wherein the functional layer (5) is configured as an at least single-layer membrane layer with a grammage of 50 g/m2 or less and contains thermoplastic polyurethane and/or thermoplastic copolyester elastomer, in particular consists thereof, so that a composite is formed, and
(b) in a subsequent second method step, the side of the composite on which the functional layer (5) is arranged is applied to a protective layer (6), wherein the protective layer (6) is configured on the basis of an acrylate- and/or polyurethane-based composition.

In the context of the present invention, it is preferably provided that the carrier layer is bonded to the functional layer. Preferably, therefore, an adhesion promoter layer is applied to the carrier layer and/or the functional layer, preferably the carrier layer, for applying the functional layer to the carrier layer.

In the context of the present invention, it is usually envisaged that the adhesion promoter layer is applied to the carrier layer using roller application, nozzle application, spray application, scatter application or the like.

The adhesion promoter layer may advantageously comprise a plastic and/or a synthetic resin, preferably a polyurethane. Preferably, the adhesion promoter layer comprises or consists of an adhesive, in particular a reactive adhesive. Particularly preferred, the adhesion promoter layer comprises a reactive hot-melt adhesive, in particular a polyurethane hot-melt, in particular consists thereof.

Preferably, the acrylate- and/or polyurethane-based composition is present, as previously mentioned, as a dispersion, in particular a highly filled dispersion. Particularly good results are obtained if the dispersion is an aqueous dispersion.

As far as the application of the acrylate- and/or polyurethane-based composition to the composite is concerned, this can be effected in a variety of ways. However, in the context of the present invention, it is usually envisaged that the acrylate- and/or polyurethane-based composition is applied to the composite using rollers, nozzles, spraying, brushing, scraping or the like, preferably scraper.

In the context of the present invention, it may further be provided that after the application of the acrylate- and/or polyurethane-based composition to the composite, the composite film is dried at temperatures in the range from 120 to 200° C., in particular 130 to 180° C.

In addition, it may also be provided that further layers, in particular carrier layers, functional layers and/or protective layers, are applied to the composite before applying the protective layer to the composite.

The subject-matter of the present invention and further features, advantages and possible applications of the present invention are apparent in a non-limiting manner from the following description of embodiments and from the drawings and the drawings themselves. All the features described and/or illustrated form the subject-matter of the present invention, either individually or in any combination, irrespective of their summary in the claims or their relationship to one another.

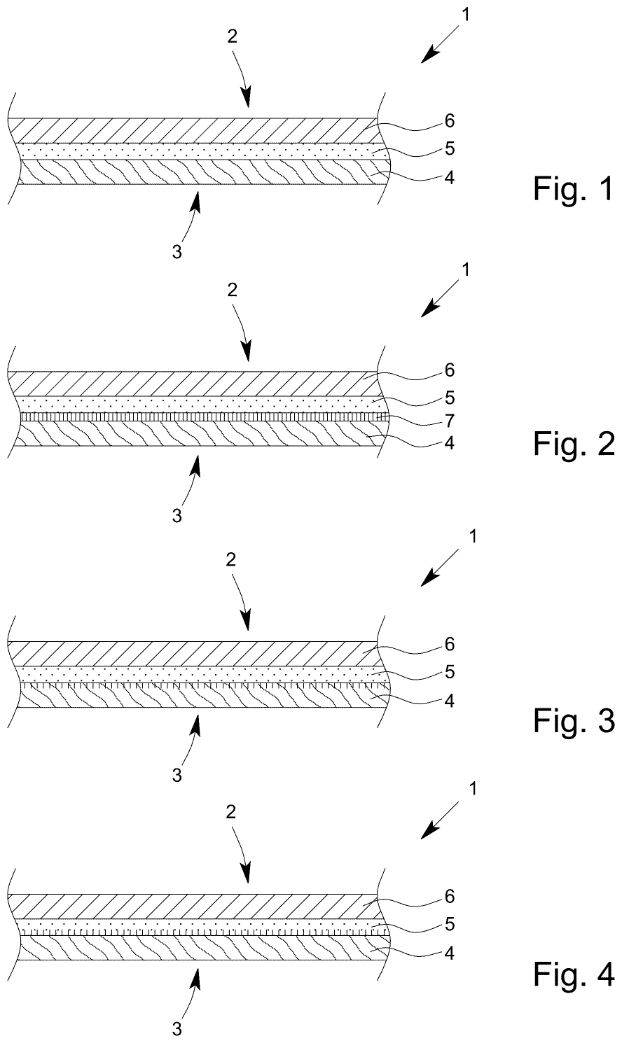

FIG. 1 shows a composite film 1 according to the invention, which comprises a carrier layer 4, a functional layer 5 and a protective layer 6. In the application case, i.e. when the composite film 1 is used in the construction sector, e.g. as a roof and/or facade membrane, the protective layer 6 preferably forms the outer side 2 of the composite film 1 and the carrier layer 4 preferably lies on the inner side 3. The functional layer 5 is arranged between the carrier layer 4 and the protective layer 6.

The carrier layer 4 is configured as a nonwoven layer, wherein this is preferably a spunbonded nonwoven. The nonwoven layer preferably contains a polymeric material or a plastic material, in particular consists of this.

Advantageously, the nonwoven layer may comprise fibers of one or more components, in particular monocomponent fibers, bicomponent fibers and/or multicomponent fibers, wherein monocomponent fibers and/or bicomponent fibers are preferred. Furthermore, it may be provided that the nonwoven layer contains or consists of fibers of different polymeric materials or plastic materials, in particular is a staple fiber nonwoven.

With regard to the polymeric material or the plastic material of the nonwoven layer, it is well proven if the nonwoven layer contains one or more materials selected from polyolefinic materials, polyester-based materials, materials from thermoplastic polyurethanes and mixtures thereof, in particular if it consists thereof. The polyolefinic material is preferably selected from the group of polyolefin homopolymers, in particular polyethylene, polypropylene, polybutylene, polyhexylene, preferably polyethylene, polypropylene, preferably polypropylene; polyolefin copolymers, in particular ethylene copolymers, propylene copolymers, butylene copolymers, hexylene copolymers, preferably ethylene copolymers, propylene copolymers, preferably propylene copolymers, and mixtures thereof. Particularly preferred, the polyolefin-based material comprises polypropylene, in particular consists of or is polypropylene. The polyester-based material is in particular selected from polymers of terephthalic acid, in particular copolymers of terephthalic acid, and is preferably polyethylene terephthalate. The thermoplastic polyurethane material is in particular selected from ether-type thermoplastic polyurethane, ester-type thermoplastic polyurethane and carbonate-type thermoplastic polyurethane, in particular ether-type and/or carbonate-type. Preferably, the nonwoven layer is composed of a polyolefinic material, preferably polypropylene.

Furthermore, the polymeric material or the plastic material of the non-woven layer may also contain additives.

Advantageously, the carrier layer 4 or nonwoven layer comprises a grammage in the range from 50 to 250 g/m2, in particular from 80 to 180 g/m2, preferably from 100 and 150 g/m2.

With regard to the protective layer 6, it is envisaged that this is configured on the basis of an acrylate- and/or polyurethane-based, preferably an acrylate-based composition, preferably an acrylate-based composition. Advantageously, the protective layer 6 is also configured as a, in particular microporous and/or open-pored, foam layer or comprises a microporous and/or open-pored foam. In particular, this ensures that the protective layer 6 provides effective protection against UV radiation and is configured to be permeable to water vapor. Preferably, the protective layer 6 is free of hydrophobizing agents.

Preferably, the protective layer 6 comprises a grammage in the range from 20 to 250 g/m2, in particular from 40 to 160 g/m2, preferably from 60 to 130 g/m2.

As regards the acrylate- and/or polyurethane-based composition, this is preferably present as a dispersion, in particular a highly filled dispersion, and preferably comprises a polymer or plastic content of 25% or more, in particular 35% or more, preferably 45% or more, based on the total composition.

The acrylate base is advantageously selected from acrylic acid esters, methacrylic acid esters and mixtures thereof. Further preferably, the acrylate and/or polyurethane-based composition may comprise additives, wherein the additives are selected from the group consisting of antioxidants, UV absorbers, UV stabilizers, colorants, flame retardants, an antistatic agent, lubricants, metal deactivators, hydrophilizing agents, antifogging additives, biocides and mixtures thereof. Preferably, the acrylate and/or polyurethane-based composition comprises UV stabilizers, flame retardants, antioxidants and/or stabilizers. Particularly preferred, the acrylate- and/or polyurethane-based composition, in particular the acrylate-based composition, comprises expandable graphite as a flame retardant. It has been found to be advantageous if the additives are present in amounts in a range from 5 to 20 wt. %, in particular 10 to 15 wt. %, preferably 11 to 13 wt. %, based on the total composition.

With regard to the functional layer 5, it is provided that this is configured as an at least single-layer membrane layer with a grammage of 50 g/m2 or less and contains thermoplastic polyurethane and/or thermoplastic copolyester elastomer, in particular consists thereof. Preferably, the functional layer 5 contains or consists in particular of thermoplastic polyurethane. Thermoplastic polyurethane is characterized in particular by its intrinsic flame-retardant effect and good long-term aging behavior, preferably for service lives of more than 10 years.

The thermoplastic polyurethane of the functional layer 5 is preferably selected from the group of aliphatic and/or aromatic polyurethanes, in particular the ether type, the ester type, the carbonate type, and mixtures thereof, in particular the aliphatic and/or aromatic polyurethanes of the carbonate type, preferably the aromatic polyurethanes of the carbonate type. In addition, the thermoplastic polyurethane of the functional layer 5 may contain additives.

The functional layer 5 is preferably configured as a monolithic membrane layer. Based on monolithic membrane layers in particular, a special efficient water vapor transport through the composite film 1 according to the invention can be achieved.

In the context of a particularly preferred embodiment of the present invention, as shown in FIG. 7, it may be provided that the functional layer 5 is configured as a multilayer film and comprises, in particular, a first and a second layer. Preferably, the functional layer 5 of the composite film 1 according to this preferred embodiment comprises a first and a second layer in the form of monolithic layers.

A further preferred embodiment of the composite film 1 according to the invention is shown in FIG. 2. In addition to a carrier layer 4, a functional layer 5 and a protective layer 6, the composite film comprises an adhesion promoter layer 7. Preferably, the adhesion promoter layer 7 is arranged between the carrier layer 4 and the functional layer 5. A configuration of the composite film according to the invention in which the adhesion promoter layer 7 is arranged between the functional layer 5 and the protective layer 6 is also conceivable.

Advantageously, the adhesion promoter layer 7 can be configured as an adhesive layer and/or the adhesion promoter can be configured as an adhesive. Preferably, the adhesion promoter layer 7 and/or the adhesive layer enables material bonding of the layers to be joined with each other.

The adhesion promoter layer 7 may comprise a polymer, in particular an adhesion promoter polymer, which preferably comprises a plastic and/or a synthetic resin, preferably polyurethane. Particularly preferred, the adhesion promoter layer 7 and/or the adhesion promoter polymer comprises a reactive hot-melt adhesive, in particular a polyurethane hot-melt, in particular consists thereof.

As shown in FIGS. 3 and 4, the adhesion promoter layer can also be firmly bonded to the functional layer 5 (see FIG. 4) or the carrier layer 4 (see FIG. 3). A comparable configuration is also conceivable for the protective layer 6.

Overall, it is preferred according to the invention if the adhesion promoter layer 7 comprises a grammage in the range from 1 to 15 g/m2, in particular from 2 to 10 g/m2, preferably from 3 to 7 g/m2.

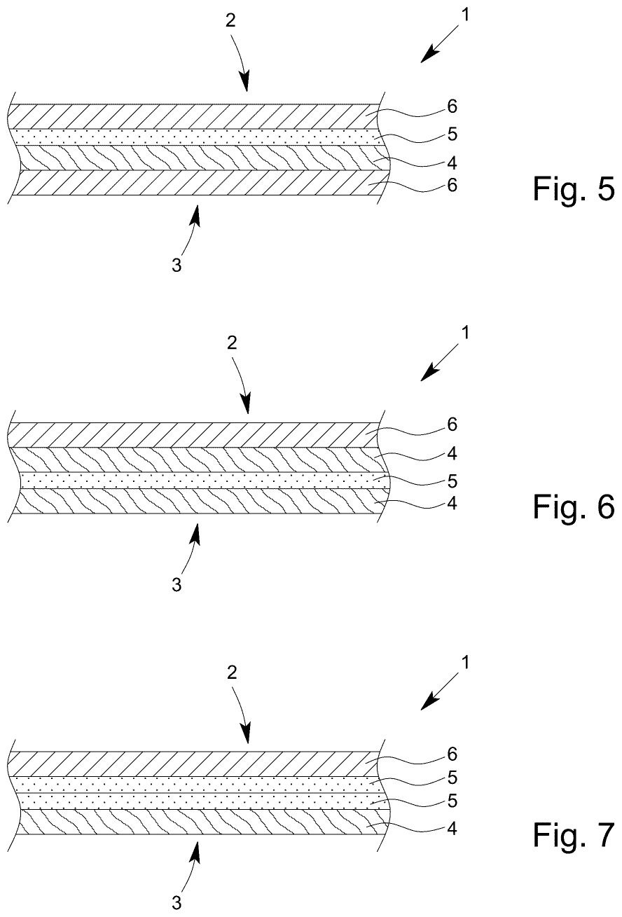

In the context of a further preferred embodiment of the present invention, shown in FIG. 5, a composite film 1 comprises two protective layers 6, in particular wherein the protective layers 6 are arranged on both the outer side 2 and the inner side 3 of the composite film 1 according to the invention.

This configuration can be advantageous if it is to be feared that there is also the possibility of UV radiation penetrating to the under-roof membrane on the inside of the roof structure or the respective installation situation. This can be the case, for example, through cut-outs for roof windows or similar. According to the embodiment shown in FIG. 5, local damage to the under-roof membrane can be prevented at the points exposed to UV radiation from the inside.

For a very special robust configuration of the composite film according to the invention, it can also be provided that a further carrier layer 4 is provided between the functional layer 5 and the protective layer 6. A composite film 1 according to the invention is shown in FIG. 6. The additional carrier layer 4 further supports the mechanical properties of composite films 1 according to the invention and thus leads to a very special stable configuration of these.

Alternatively, at least one reinforcing layer can be arranged between the functional layer 5 and the carrier layer 4 and/or the protective layer 6 in a preferred embodiment of the present invention, which is not shown. In particular, a reinforcing layer can be arranged between the carrier layer 4 and the functional layer 5 and between the protective layer 6 and the functional layer 5. The reinforcing layer can be configured as a leno fabric. A composite film 1 configured according to FIG. 6 is characterized by a particularly high mechanical load-bearing capacity, just like composite films 1 according to FIG. 6.

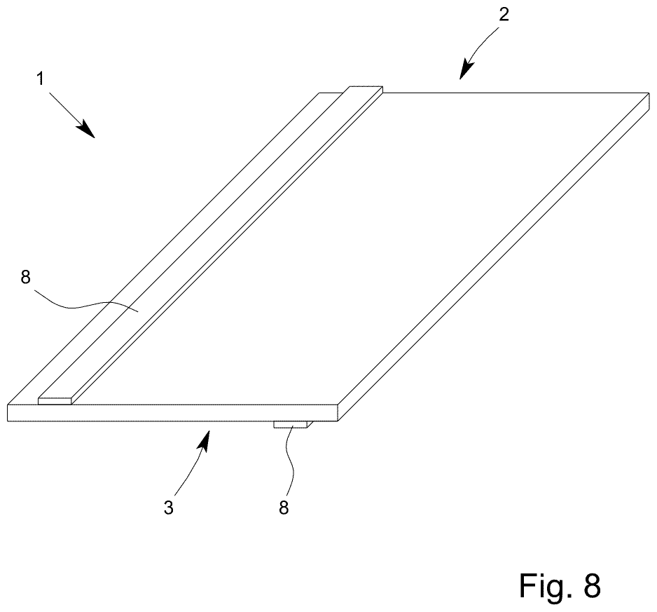

A further preferred embodiment of a composite film 1 according to the invention is shown in FIG. 8. Here, it is advantageously provided that at least one longitudinal edge-side adhesive zone 8 is arranged on the surfaces, in particular the upper side or outer side 2 and/or the lower side or inner side 3, of the composite film 1.

The longitudinal edge-side adhesive zone 8 is used for bonding adjacent composite films 1 to produce a coherent film layer consisting of individual composite film strips. Advantageously, the adhesive zone 1 on the longitudinal edge is spaced from the longitudinal edge of the composite film 1. Further preferably, the adhesive zone 8 can be configured in the form of strips, possibly in the form of interrupted strips. It is well proven if the adhesive zone 8 comprises a width of between 2 and 10 cm The composite film can now comprise one adhesive zone 8, two adhesive zones 8, as also shown in FIG. 8, and/or a plurality of adhesive zones 8, for example four adhesive zones 8.

The adhesive zones are preferably between 1 and 90 mm from the longitudinal edge, preferably between 3 and 70 mm, more preferably between 5 and 50 mm, and have a particularly strip-shaped configuration for a clean and simple arrangement of the sheets on top of one another, in particular in the case of an adhesive-in-adhesive bond.

### WORKING EXAMPLES

### 1. Production of Composite Films

### Example 1

A functional layer comprising, or in particular consisting of, TPU of the ether type with a grammage of 30 g/m2 is laminated onto a PET carrier nonwoven layer with a grammage of 150 g/m2, for which a reactive PU hotmelt with a grammage of 5 g/m2 is used.

A protective layer with a grammage of 120 g/m2, based on the dry weight of the protective layer, is then scraped onto the TPU functional layer. The protective layer is based on an acrylate/methacrylate dispersion, which also contains 3.5 wt. % UV-absorbing colorant, 7 wt. % flame retardant and 1.5 wt. % UV stabilizer and a crosslinking agent and has been foamed in an impact foaming machine with compressed air.

The composite film obtained in this way is then dried at 150° C. and crosslinked.

### Example 2

A functional layer comprising, or in particular consisting of, ether-type TPU with a grammage of 30 g/m2 is laminated onto a PET carrier nonwoven layer with a grammage of 150 g/m2, for which a reactive PU hotmelt with a grammage of 5 g/m2 is used.

A protective layer with a grammage of 100 g/m2, based on the dry weight of the protective layer, is then scraped onto the TPU functional layer. The protective layer is based on an acrylate/methacrylate dispersion, which also contains 3.5 wt. % UV-absorbing colorant, 7 wt. % flame retardant and 1.5 wt. % UV stabilizer and a crosslinking agent and has been foamed in an impact foaming machine with compressed air.

The composite film obtained in this way is then dried at 150° C. and crosslinked.

### Example 3

A functional layer comprising, or in particular consisting of, ether-type TPU with a grammage of 30 g/m2 is laminated onto a PET carrier layer with a grammage of 130 g/m2, for which a reactive PU hotmelt with a grammage of 5 g/m2 is used.

A protective layer with a grammage of 120 g/m2, based on the dry weight of the protective layer, is then scraped onto the TPU functional layer. The protective layer is based on an acrylate/methacrylate dispersion, which also contains 3.5 wt. % UV-absorbing colorant, 7 wt. % flame retardant and 1.5 wt. % UV stabilizer and a crosslinking agent and has been foamed in an impact foaming machine with compressed air.

The protective layer is subjected to a cross-linking step and the composite film thus obtained is finally dried at 150° C.

### Example 4

A functional layer comprising, or in particular consisting of, ether-type TPU with a grammage of 30 g/m2 is laminated onto a carrier layer of a bicomponent fiber nonwoven with a grammage of 100 g/m2, for which a reactive PU hotmelt with a grammage of 5 g/m2 is used. The bicomponent fiber nonwoven comprises bicomponent fibers based on polypropylene in both the core and the sheath, wherein the polypropylene used in the core and sheath was produced using metallocene and Ziegler-Natta catalysis.

A protective layer with a grammage of 120 g/m2, based on the dry weight of the protective layer, is then scraped onto the TPU functional layer. The protective layer is based on an acrylate/methacrylate dispersion, which also contains 3.5 wt. % UV-absorbing colorant, 7 wt. % flame retardant and 1.5 wt. % UV stabilizer and a crosslinking agent and has been foamed in an impact foaming machine with compressed air.

The protective layer is subjected to a cross-linking step and the composite film thus obtained is finally dried at 130° C.

### Example 5

A functional layer comprising, or in particular consisting of, ether-type TPU with a grammage of 30 g/m2 is laminated onto a carrier layer of a bicomponent fiber nonwoven with a grammage of 130 g/m2, for which a reactive PU hotmelt with a grammage of 5 g/m2 is used. The bicomponent fiber nonwoven comprises bicomponent fibers based on polypropylene in both the core and the sheath, wherein the polypropylene used in the core and sheath was produced using metallocene and Ziegler-Natta catalysis.

A protective layer with a grammage of 80 g/m2, based on the dry weight of the protective layer, is then scraped onto the TPU functional layer. The protective layer is based on an acrylate/methacrylate dispersion, which also contains 3.5 wt. % UV-absorbing colorant, 7 wt. % flame retardant and 1.5 wt. % UV stabilizer and a crosslinking agent and has been foamed in an impact foaming machine with compressed air.

The protective layer is subjected to a cross-linking step and the composite film thus obtained is finally dried at 130° C.

### COMPARATIVE EXAMPLE

A protective layer with a grammage of 120 g/m2, based on the dry weight of the protective layer, is scraped onto a PET carrier nonwoven layer with a grammage of 150 g/m2. The protective layer is based on an acrylate/methacrylate dispersion, which also contains 3.5 wt. % UV-absorbing colourant, 7 wt. % flame retardant and 1.5 wt. % UV stabilizer and a cross-linking agent and has been foamed in an impact foaming machine with compressed air.

The composite film obtained in this way is then dried at 150° C.

### 2. Mechanical and Physical Properties of the Composite Films

The composite films of examples (Ex.) 1 to 5 are examined with regard to their properties and the results obtained are compared with the values for the composite film according to the comparative example (Comp. Ex.).

The grammage FG ([g/m2]), the tensile strength or tear strength Rk ([N/5 cm]) in longitudinal and cross direction, the elongation at break Rd ([%]) in longitudinal and cross direction, the nail pull-out force NAK ([N]) in longitudinal and cross direction, the dynamic water column WS ([mm]) and the Sd value (according to 50/93) as well as whether the composite films pass fire test class E are determined. All determinations are effected in accordance with the current DIN EN ISO standards or ASTM standards.

The results obtained are summarized in Tables 1 and 2 below.

TABLE 1
Test results for laminated films according to examples 1 to 5 and the comparative film

| | Comp. | | | | | |
|---|---|---|---|---|---|---|
| | Ex. | Ex. 1 | Ex. 2 | Ex. 3 | Ex. 4 | Ex. 5 |
| FG [g/m²] | 270 | 305 | 285 | 285 | 255 | 243 |
| Rk [N/5 cm] | 370/270 | 379/303 | 376/375 | 387/293 | 367/264 | 415/322 |
| lengthwise/ | | | | | | |
| crosswise | | | | | | |
| Rd [%] | 20/50 | n.d.¹ | n.d.¹ | 50/59 | 77/100 | 73/92 |
| lengthwise/ | | | | | | |
| crosswise | | | | | | |
| NAK [N] | 150/150 | 118/152 | 146/132 | 162/179 | 131/211 | 146/223 |
| lengthwise/ | | | | | | |
| crosswise | | | | | | |
| WS [mm] | 600-800 | 19.200 | 16.100 | 18.200 | 14.600 | 18.500 |
| S_{d}-Wert | 0.02 | 0.13 | 0.12 | 0.11 | 0.13 | 0.12 |
| Test cl. E | 5:0/5:0 | 5:0/5:0 | 5:0/5:0 | 5:0/5:0 | 5:0/5:0 | 5:0/5:0 |

¹n.d. = not determined

TABLE 2
Evaluation of the test results of laminated films according
to examples 1 to 5 in relation to the comparison film

| | Comp. | | | | | |
|---|---|---|---|---|---|---|
| | Ex. | Ex. 1 | Ex. 2 | Ex. 3 | Ex. 4 | Ex. 5 |
| FG [g/m²] | 270 | − | 0 | 0 | + | ++ |
| Rk [N/5 cm] | 370/270 | +/+ | +/+ | +/+ | 0/0 | ++/++ |
| lengthwise/ | | | | | | |
| crosswise | | | | | | |
| Rd [%] | 20/50 | n.d. | n.d. | +/+ | ++/++ | ++/++ |
| lengthwise/ | | | | | | |
| crosswise | | | | | | |
| NAK [N] | 150/150 | −/0 | 0/− | +/+ | −/++ | 0/++ |
| lengthwise/ | | | | | | |
| crosswise | | | | | | |
| WS [mm] | 600-800 | ++ | ++ | ++ | ++ | ++ |
| S_{d}-Wert | 0.02 | − | − | − | − | − |
| Test cl. E | 5:0/5:0 | 0 | 0 | 0 | 0 | 0 |

Legend:
++ = significantly better,
+ = better,
0 = same,
− = worse (in relation to the comparison example)
n.d. = not determined

The composite films according to examples 3 to 5 should be emphasized as having particular advantages over the comparative example from the prior art. Likewise, the composite films according to the invention according to Example 1 and Example 2 are characterized by good to excellent mechanical properties and, above all, by a special high water resistance. This can be observed for all composite films according to the invention and in all cases clearly exceeds the watertightness of conventional multilayer films.

In addition, the long-term ageing resistance of composite films according to example 3 was investigated. The composite films were aged under different test conditions and the watertightness of the composite films was determined before and after ageing. The results obtained in this regard are summarized in Table 3:

TABLE 3
Long-term ageing resistance of composite films according
to the invention according to example 3

| | | Water | Water |
|---|---|---|---|
| | | column | column |
| Examination | Duration | (befire) [mm] | (after) [mm] |
| ,,Hurricane oven“ | 64 weeks | 19.400 | 17.000 |
| 70° C., 5 m/s air movement | | | |
| 70° C./90% rel. humidity | 60 weeks | 19.200 | 4.300 |
| QUV (UV-irradiation), | 60 weeks | 18.400 | 7.000 |
| according to DIN EN 13859 | | | |
| ,,Florida-weathering“, | 48 weeks | 19.200 | 11.700 |
| according to ASTM G7 2011 | | | |

The results of the long-term ageing resistance tests show that composite films according to the invention are stable even under harsh weather conditions over a long period of time.

On the basis of the still excellent waterproofness and robustness of composite films according to the invention, it can therefore be assumed that they have outstanding weather resistance overall, while at the same time being highly resistant to mechanical stress. In this aspect, composite films according to the invention are clearly superior to the state of the art.

In addition, it is possible to achieve significantly optimized grammages and thus a material-efficient composite film. It is noteworthy that, in particular for examples 4 and 5, a significant reduction in the overall grammage of the composite films can be achieved, while at the same time an increase in mechanical load-bearing capacity values and building physics parameters is achieved. These outstanding results are based both on the combination of materials as selected according to the examples and on an optimized coordination of the use of materials and grammage for each individual layer of the composite films.

Overall, the films provided by the present invention can be regarded as advantageous compared to the prior art and as positive with regard to the property profile achieved.

### REFERENCE SIGNS

1 Composite film
2 Outer side
3 Inner side
4 Carrier layer
5 Functional layer
6 Protective layer
7 Adhesive layer
8 Adhesive zones

1. A composite film comprising,
at least one carrier layer configured as a non-woven layer;
at least one protective layer comprising an acrylate- and/or polyurethane-based composition; and
at least one functional layer arranged between the carrier layer and the protective layer,
wherein the functional layer is configured as an at least single-layer membrane layer with a grammage of 50 g/m2 or less and comprises thermoplastic polyurethane and/or thermoplastic copolyester elastomer.

2. The composite film according to claim 1, wherein the nonwoven layer is an at least single-layer, spunbonded nonwoven.

3. The composite film according to claim 1, wherein the nonwoven layer comprises a polymeric material selected from polyolefinic materials, polyester-based materials, thermoplastic polyurethane materials and mixtures thereof.

4. The composite film according claim 1, wherein the carrier layer comprises a grammage in the range of 50 to 250 g/m2.

5. The composite film according to claim 1, wherein the protective layer comprises at least an acrylate and/or at least a polyurethane.

6. The composite film according claim 1, wherein the protective layer is configured as a microporous foam layer.

7. The composite film according to claim 1, wherein the protective layer comprises a grammage in the range of 20 to 250 g/m2.

8. The composite film according to claim 1, wherein the functional layer (5) is configured as a monolithic membrane layer.

9. The composite film according to claim 1, wherein the thermoplastic polyurethane of the functional layer is selected from the group of aliphatic and/or aromatic polyurethanes.

10. The composite film according to claim 1, wherein the functional layer comprises a grammage of 40 g/m2 or less.

11. The composite film according to claim 1, wherein the composite film comprises an adhesion promoter layer arranged between the carrier layer and the functional layer and/or between the functional layer and the protective layer.

12. The composite film according claim 1, wherein the composite film is configured to withstands a water column of more than 2,000 mm according to DIN EN ISO 811:2018-08.

13. The composite film according to claim 1, wherein the composite film has a tensile strength according to ASTM D1004 and ASTM D1925 in a range of at least 300 N/5 cm in the machine direction and/or at least 200 N/5 cm in the cross direction.

14. The composite film according claim 1, wherein the composite film comprises an elongation at break according to ASTM D1004 and ASTM D1925 of at least 40% in the machine direction and/or at least 50% in the cross direction.

15. The composite film according to claim 1, wherein the composite film comprises a specific nail pull-out force according to EN 12310-1 of at least 120 N in the machine direction and/or at least 150 N in the cross direction.

16. The composite film according to claim 1, wherein the composite film comprises an ageing stability of at least 15 years, wherein the aging stability is determined by subjecting the composite film to an artificial aging process carried out at a temperature of 70±2° C. and an air velocity of 5±2 m/s, and wherein following the artificial ageing process, the water impermeability of the composite film is tested in accordance with DIN EN 13859-1-2010-11, section 5.2.3, against a water column of at least 200 mm over a period of 2 h.

17. The composite film according to claim 16, wherein the composite film comprises an ageing stability of at least 20 years.

18. The composite film according to claim 16, wherein the artificial ageing process for determining the ageing stability is carried out over a period of at least 30 weeks.

19. The composite film according to claim 1, wherein the composite sheet is configured as a roof and/or facade sheet.

20. The composite film according claim 1, wherein the composite sheet is configured for use as a roof and/or facade membrane in the construction sector.

21. A method for producing a composite film, the method comprising:
(a) in a first method step, loading a carrier layer configured as a nonwoven layer with a functional layer, wherein the functional layer is configured as an at least single-layer membrane layer with a grammage of 50 g/m2 or less and comprises thermoplastic polyurethane and/or thermoplastic copolyester elastomer; and
(b) in a subsequent second method step, applying to a protective layer a side of the composite on which the functional layer is arranged, wherein the protective layer is configured as an acrylate- and/or polyurethane-based composition.
